(19) United States
(12) Patent Application Publication
(10) Pub. No.: US 2021/0086367 A1
(43) Pub. Date: Mar. 25, 2021

(54) ROBOT AND OPERATION METHOD FOR ROBOT

(71) Applicant: LG ELECTRONICS INC., Seoul (KR)

(72) Inventors: Taeyoung CHOI, Seoul (KR); Changwoo SON, Paju-si (KR); Sunggil PARK, Paju-si (KR); Seyul SON, Paju-si (KR); Seukwoo RYU, Paju-si (KR)

(73) Assignee: LG ELECTRONICS INC., Seoul (KR)

(21) Appl. No.: 16/727,329

(22) Filed: Dec. 26, 2019

(30) Foreign Application Priority Data
Sep. 20, 2019 (KR) 10-2019-0116011

(51) Int. Cl. B25J 11/00; B25J 19/00; B25J 15/00; B25J 9/16; B25J 19/02; H05B 1/02

(52) U.S. Cl. CPC B25J 11/00; B25J 19/0025; B25J 15/0019; B25J 9/161; B25J 19/02; H05B 1/02; B25J 9/1633

(57) ABSTRACT

Disclosed is a robot. The robot includes a manipulator for performing movement, a scoop connected to the manipulator, and for receiving matter, and a controller for controlling the robot, wherein the controller increases temperature of a first part of the scoop when the robot performs a scooping operation of putting the matter into the scoop.

### CROSS REFERENCE TO RELATED APPLICATION

The present application claims priority to Korean Patent Application No. 10-2019-0116011, filed Sep. 20, 2019, the entire contents of which is incorporated by reference herein for all purposes into the present application.

### BACKGROUND OF THE INVENTION

### Field of the Invention

Embodiments of the present disclosure relate to a robot and an operation method for the robot.

### Description of the Related Art

Generally, a robot is a machine capable of automatically carrying out or operating a given operation by its own ability, and the robot is used in various fields such as the industrial field, medical field, household field, military field, etc. Recently, a communication type robot capable of performing communication or interaction with persons through voice or gesture has been increased.

Also, a robot providing foods to a user has been introduced. For example, a robot capable of scooping out food from a specific container and providing the same to a user or a robot capable of making foods according to a recipe has been developed. However, precise and delicate manipulations are required for providing or making foods, and thus controlling a robot has to become more precise.

The foregoing is intended merely to aid in the understanding of the background of the present invention, and is not intended to mean that the present invention falls within the purview of the related art that is already known to those skilled in the art.

### SUMMARY OF THE INVENTION

An objective of the present disclosure is to provide a robot and an operation method for the robot, the robot being capable of scooping of and releasing coagulated matter by using a scoop, and easily performing scooping and releasing operations by adjusting temperature of the scoop during the scooping and releasing operations.

A robot according to embodiments of the present disclosure includes: a manipulator configured to perform movement; a scoop connected to the manipulator, and configured to receive matter therein; and a controller configured to control the robot, wherein the controller increases temperature of a first part of the scoop when the robot performs a scooping operation of putting the matter into the scoop.

A method of operating a robot including a manipulator and a scoop for receiving matter according to embodiments of the present disclosure includes: receiving a start command; moving the scoop to around the matter in response to the start command; performing a scooping operation of scooping out the matter by using the scoop; and increasing temperature of a first part of the scoop when performing the scooping operation.

A scoop for receiving matter according to embodiments of the present disclosure includes: a first part through which the matter passes; a second part in which the matter having passed the first part is received; a temperature adjusting element disposed close to the first part and the second part, temperature thereof being adjusted by an external power source; and a power supply line transferring the external power source to the temperature adjusting element.

According to a robot and an operation method for the robot according to embodiments of the present disclosure, the user can be provided with matter by automatically scooping out and releasing the matter.

According to a robot and an operation method for the robot according to embodiments of the present disclosure, scooping and releasing operations can be easily performed by adjusting temperature of the scoop during the scooping and releasing operations.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing an AI apparatus according to an embodiment of the present disclosure;

FIG. 2 is a view showing an AI sever according to an embodiment of the present disclosure;

FIG. 3 is a view showing an AI system according to an embodiment of the present disclosure;

FIG. 4 is a view showing a robot according to an embodiment of the present disclosure;

FIGS. 5 and 6 are views respectively showing operational examples of the robot according to embodiments of the present disclosure;

FIG. 7 is a view showing a scoop according to embodiments of the present disclosure;

FIG. 8 is a view showing some components of the robot according to embodiments of the present disclosure;

FIG. 9 is a view of a flowchart showing an operation method of the robot according to embodiments of the present disclosure;

FIG. 10 is a view of a flowchart showing an operation method of the robot according to embodiments of the present disclosure;

FIG. 11 is a view of a flowchart showing an operation method of the robot according to embodiments of the present disclosure; and

FIG. 12 is a view of a flowchart showing an operation method of the robot according to embodiments of the present disclosure.

### DETAILED DESCRIPTION OF THE INVENTION

Hereinafter, embodiments of the present disclosure will be described with reference to the accompanied drawings.

Artificial intelligence refers to the field of researching artificial intelligence or the methodology to create the same, and machine learning refers to the field of defining various problems in the field of artificial intelligence and researching the methodology for solving the problems. Machine learning is defined as an algorithm that improves the performance of an operation by performing a consistent experience for the operation.

An artificial neural network (ANN) is a model used in machine learning, configured with artificial neurons (nodes) constituting a network in a synapse coupling, and means a model with problem solving ability. The artificial neural network can be defined by a connection pattern between neurons of other layers, a learning process of updating a model parameter, and an activation function generating an output value.

The artificial neural network can include an input layer, an output layer, and at least one selective hidden layer. Each layer can include at least one neuron, and the artificial neural network can include a synapse that connects neurons. In the artificial neural network, each neuron can output input signals input through a synapse, weights, and a function value of an activation function for a bias.

The model parameter means a parameter determined through learning, and includes a weight of a synapse connection, a bias of a neuron, etc. In addition, a hyper-parameter means a parameter that has to be set before performing learning in a machine learning algorithm, and includes a learning rate, a number of repetition times, a size of a mini-batch, an initialization function, etc.

An objective of performing learning for an artificial neural network is to determine a model parameter that minimizes a loss function. The loss function can be used as an index for determining an optimum model parameter in a learning process of the artificial neural network.

Machine learning can be classified into supervised learning, unsupervised learning, and reinforcement learning according to a learning method.

Supervised learning can mean a method of performing learning for an artificial neural network where a label related to learning data is provided, and the label can mean a right answer (or result value) that has to be estimated by the artificial neural network when the learning data is input to the artificial neural network. Unsupervised learning can mean a method of performing learning for an artificial neural network where a label related to learning data is not provided. Reinforcement learning can mean a learning method performing learning so as to select, by an agent defined under a certain environment, an action or an order thereof such that an accumulated reward in each state is maximized.

Machine learning, among artificial neural networks, employed in a deep neural network (DNN) including a plurality of hidden layers, is referred to as deep learning, and the deep learning is a part of the machine learning. Hereinafter, machine learning is used to include deep learning.

A robot can mean a machine capable of automatically carrying out or operating a given operation by its own ability. Particularly, a robot having a function of recognizing an environment, and performing an operation by performing determination by itself can be referred to as an intelligent robot.

A robot can be classified into an industrial type, a medical type, a household type, a military type, etc. according to the usage purpose or field.

A robot can perform various physical operations such as moving a robot joint by including a manipulator including an actuator or motor. In addition, a movable robot can navigate on the ground or fly in the air by including wheels, brakes and propellers, etc.

Self-driving means the technology of autonomous driving, and a self-driving vehicle means a vehicle that drives without user's manipulations or with the minimum manipulation of the user.

For example, self-driving can include the technique of maintaining a driving lane, the technique of automatically adjusting a speed such as adaptive cruise control, the technique of automatically driving along a predetermined route, the technique of automatically setting a route when a destination is set, etc.

Vehicles can include a vehicle with only an internal combustion engine, a hybrid vehicle with an internal combustion engine and an electric motor together, and an electric vehicle with only an electric motor, and can include not only automobiles but also trains and motorcycles.

Herein, a self-driving vehicle can be referred to as a robot with a self-driving function.

Extended reality refers to virtual reality (VR), augmented reality (AR), and mixed reality (MR). The VR technique provides objects and backgrounds of the real world in CG images, the AR technique provides virtual CG images by reflecting the same on real object images, and the MR technique is a computer graphic technique mixing and coupling virtual objects and providing by reflecting the same in the real word.

The MR technique is similar to the AR technique in that real objects and virtual objects are provided together. In the AR technique, virtual objects are used to complement real objects, but in the MR technique, virtual objects and real objects are equivalently used.

The XR technique (i.e., cross reality, which may be a mixed reality environment utilizing sensors/actuators) can be applied by using a head-mount display (HIVID), a head-up display (HUD), a mobile phone, a tablet PC, a laptop PC, a desktop PC, a TV, a digital signage, etc., and a device to which the XR technique is applied can be referred to an XR device.

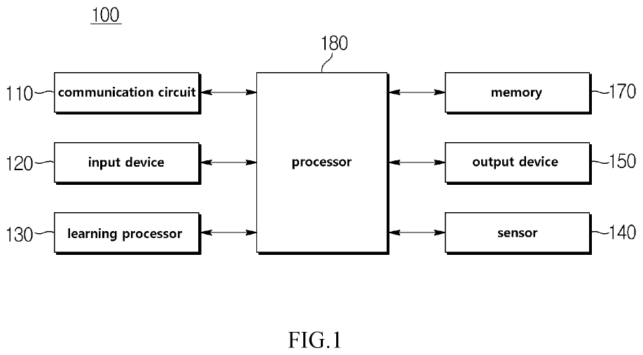

FIG. 1 is a view showing an AI apparatus 100 according to an embodiment of the present disclosure.

The AI apparatus 100 can be employed in a fixed or movable type device such as TVs, projectors, mobile phones, smart phones, desktop PCs, laptop PCs, digital broadcasting terminals, PDAs (personal digital assistants), PNIPs (portable multimedia player), navigations, tablet PCs, wearable devices, set-top boxes (STB), DMB receiver, radios, washers, refrigerators, digital signages, robots, vehicles, etc.

Referring to FIG. 1, the AI apparatus (or terminal) 100 can include a communication circuit 110, an input device 120, a learning processor 130, a sensor 140, an output device 150, a memory 170, and a processor 180.

The communication circuit 110 can transmit and receive data to/from another AI apparatuses (100a to 100e) or external devices such as an AI sever 200 by using wired/wireless communication methods. For example, the communication circuit 110 can transmit and receive sensor information, user input, learning model, control signals, etc. to/from external devices.

Herein, communication methods used by the communication circuit 110 include global system for mobile communication (GSM)), code division multi access (CDMA), long term evolution (LTE), 5G, wireless LAN (WLAN), wireless-fidelity (Wi-Fi), Bluetooth™, radio frequency identification (RFID), infrared data association (IrDA), ZigBee, near field communication (NFC), etc.

The input device 120 can be for obtaining various types of data.

Herein, the input device 120 can include a camera for an image signal input, a microphone for receiving audio signals, and a user input part for receiving information from the user. Herein, signals obtained from the camera or microphone by using the same as sensors can be referred to as sensing data or sensor information.

The input device 120 can be for obtaining input data used for outputting that is performed by using learning data and a learning model for model learning. The input device 120 can be for obtaining input data that is not processed. Herein, the processor 180 or learning processor 130 can obtain an input feature from input data as preprocessing.

The learning processor 130 can perform learning for a model configured with an artificial neural network by using learning data. Herein, the artificial neural network for which learning is performed can be referred to as a learning model. The learning model can be used for estimating a result value for new input data other than learning data, and the estimated value can be used as a reference for performing a certain operation.

Herein, the learning processor 130 can perform AI processing with a learning processor 240 of the AI sever 200.

Herein, the learning processor 130 can include a memory integrated or employed in the AI apparatus 100. Alternatively, the learning processor 130 can be employed by using the memory 170, an external memory directly connected to the AI apparatus 100, or a memory maintained in an external device.

The sensor 140 can obtain at least one of internal information of the AI apparatus 100, surrounding environmental information of the AI apparatus 100, and user information by using various sensors.

Herein, the sensor 140 can include a proximity sensor, an ambient light sensor, an acceleration sensor, a magnetic sensor, a gyro sensor, an inertial sensor, an RGB sensor, an IR sensor, a fingerprint recognizing sensor, an ultrasonic sensor, an optical sensor, a microphone, a lidar, a radar, etc.

The output device 150 can generate visual, auditory, or tactile outputs.

Herein, the output device 150 can include a display for visually outputting information, a speaker for acoustically outputting information, and a haptic actuator for tactually outputting information. For example, the display can display an image or video, the speaker can output a voice or sound, and the haptic actuator can output vibration.

The memory 170 can be for storing data supporting various functions of the AI apparatus 100. For example, in the memory 170, input data obtained through the input device 120, learning data, a learning model, a learning history, etc. can be stored.

The processor 180 can determine at least one executable operation of the AI apparatus 100 which is determined on the basis of information determined or generated by using a data analysis algorithm or machine learning algorithm. In addition, the processor 180 can perform the determined operation by controlling components of the AI apparatus 100.

For the same, the processor 180 can request, retrieve, receive, or use data of the learning processor 130 or the memory 170, and control components of the AI apparatus 100 so as to perform the estimated operation of the at least one executable operation, or an operation that is determined to be desirable.

Herein, in order to perform the determined operation, the processor 180 can generate, when association with an external device is required, a control signal for controlling the corresponding external device, and transmit the generated control signal to the corresponding external device.

The processor 180 can obtain intention information on the user's input, and determine a user's requirement on the basis of the obtained intention information.

Herein, the processor 180 can obtain intention information in association with the user's input by using at least one of a STT (speech-to-text) engine converting a voice input into text strings, and a natural language processing (NLP) engine obtaining intention information of natural language.

Herein, a part of the at least one of the STT engine and the NLP engine can be configured with an artificial neural network for which learning is performed according to a machine learning algorithm. In addition, for at least one of the STT engine and the NLP engine, learning can be performed by the learning processor 130, learning can be is performed by the learning processor 240 of the AI sever 200, or learning can be performed through distribution processing of the above processors.

The processor 180 can collect record information including operation content of the AI apparatus 100 and user's feedback in association with the operation, etc. so as to store in the memory 170 or learning processor 130, or transmit the information to the external device such as an AI sever 200, etc. The collected record information can be used when updating a learning model.

The processor 180 can control a part of components of the AI apparatus 100 so as to execute application programs stored in the memory 170. Further, the processor 180 can operate components of the AI apparatus 100 by combining at least two thereof so as to execute the application programs.

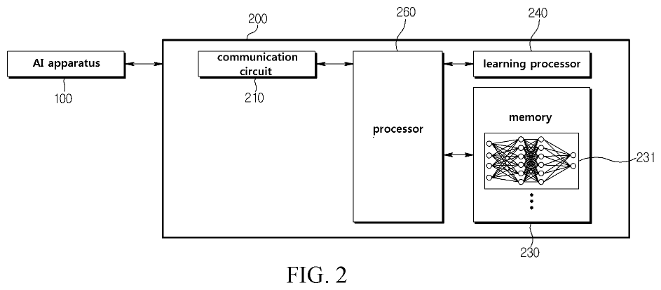

Referring to FIG. 2, an AI sever 200 can mean a device performing learning for an artificial neural network by using a machine learning algorithm, or a device using the artificial neural network for which learning is performed. Herein, the AI sever 200 can perform distributed processing by being configured with a plurality of servers, or can be defined as a 5G network. Herein, the AI sever 200 can perform at least a part of AI processing by being included as a partial component of the AI apparatus 100.

The AI sever 200 can include a communication circuit 210, a memory 230, a learning processor 240, and a processor 260.

The communication circuit 210 can transmit and receive data to/from the external devices such as an AI apparatus 100, etc.

The memory 230 can be for storing a model (or artificial neural network, 231) for which learning is ongoing or performed by the learning processor 240.

The learning processor 240 can perform learning for an artificial neural network 231 by using learning data. A learning model can be used by being integrated in the AI sever 200 of the artificial neural network, or by being integrated in the external device such as an AI apparatus 100, etc.

A learning model can be employed in hardware, software, or combination thereof. When a part or the entire of the learning model is employed in software, at least one instruction constituting the learning model can be stored in the memory 230.

The processor 260 can estimate a result value for new input data by using a learning model, and generate a response or control command on the basis of the estimated result value.

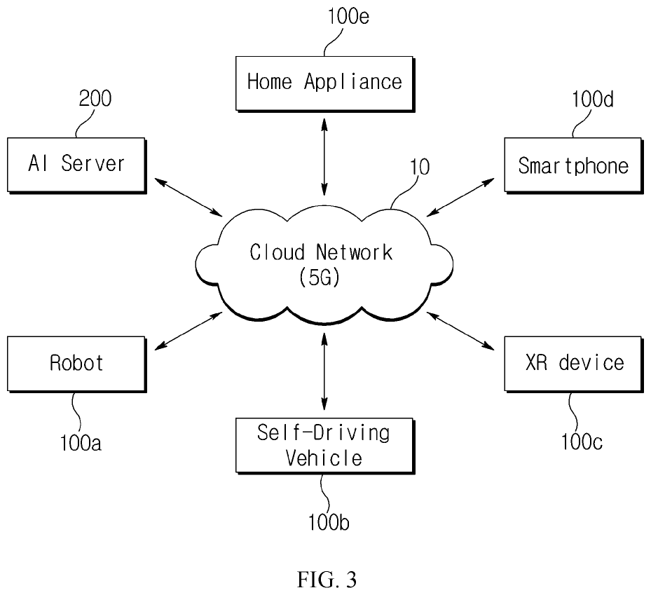

FIG. 3 is a view showing an AI system 1 according to an embodiment of the present disclosure.

Referring to FIG. 3, the AI system 1 is connected to at least one cloud network 10 among the AI sever 200, a robot 100a, self-driving vehicle 100b, an XR device 100c, a smart phone 100d, and a home appliance 100e. Herein, the robot 100a, the self-driving vehicle 100b, the XR device 100c, the smart phone 100d or the home appliance 100e to which the AI technique is applied can be referred to as the AI apparatus (100a to 100e).

The cloud network 10 can mean a network constituting a part of cloud computing infrastructure or a network present in the cloud computing infrastructure. Herein, the cloud network 10 can be configured by using a 3G network, a 4G or LTE network, a 5G network, etc.

In other words, each device (100a to 100e, 200) constituting the AI system 1 can be connected with each other through the cloud network 10. Particularly, each device (100a to 100e, 200) can perform communication with each other through a base station, and also can perform direct communication without using the base station.

The AI sever 200 can include a server performing AI processing, and a sever performing calculation for big data.

The AI sever 200 can be connected to at least one of AI apparatus constituting an AI system 1 configured with the robot 100a, the self-driving vehicle 100b, the XR device 100c, the smart phone 100d, and the home appliance 100e through the cloud network 10, and the AI sever 200 can support a part of the AI processing of the connected AI apparatuses (100a to 100e).

Herein, the AI sever 200 can perform learning on an artificial neural network according to a machine learning algorithm in place of the AI apparatus (100a to 100e), can directly store a learning model, or transmit the learning model to the AI apparatus (100a to 100e).

Herein, the AI sever 200 can receive input data from the AI apparatus (100a to 100e), estimate a result value for the received input data by using a learning model, and generate a response or control command on the basis of the estimated result value so as to transmit the same to the AI apparatus (100a to 100e).

Alternatively, the AI apparatus (100a to 100e) can estimate a result value for the received input data by directly using a learning model, and generate a response or control command on the basis of the estimated result value.

Hereinafter, various examples of the AI apparatus (100a to 100e) to which the above described technique is applied will be described. Herein, the AI apparatus (100a to 100e) shown in FIG. 3 can be referred to as a detailed example of the AI apparatus 100 shown in FIG. 1.

The robot 100a can be employed in a guide robot, a transport robot, a cleaning robot, a wearable robot, an entertainment robot, a pet robot, an unmanned flying robot, etc. by applying the AI technique thereto.

The robot 100a can include a robot control module for controlling operations, and the robot control module can mean a software module or a chip where the same is employed therein.

The robot 100a can obtain state information of the robot 100a, detect (recognize) a surrounding environment or objects, generate map data, determine a moving path or driving plan, determine a response in association with a user interaction, or determine operations by using sensor information that is obtained through various types of sensors.

Herein, in order to determine a moving path or driving plan, the robot 100a can use sensor information obtained by using at least one sensor of a lidar, a radar, and a camera, including any combination thereof.

The robot 100a can perform the above operations by using a learning model configured with at least one artificial neural network. For example, the robot 100a can recognize a surrounding environment and objects by using a learning model, and determine operations by using the recognized surrounding environment information or object information. Herein, the learning model can be obtained by directly performing learning by the robot 100a, or by performing learning by the external device such as an AI sever 200, etc.

Herein, the robot 100a can generate a result by directly using the learning model so as to perform operations. However, the robot 100a can transmit the sensor information to the external device such as an AI sever 200, and receive a result generated according thereto so as to perform operations.

The robot 100a can determine a moving path and a driving plan by using at least one map data, object information detected from the sensor information, and object information obtained from the external device, and drive according to the determined moving path and the driving plan by controlling a driving part.

Map data can include object identification information on various objects arranged in a space where the robot 100a moves. For example, the map data can include object identification information on fixed objects such as walls, doors, etc., and movable objects such as flowerpots, tables, etc. In addition, the object identification information can include a name, a type, a distance, a position, etc.

In addition, the robot 100a can perform operations or drive by controlling the driving part on the basis of the user's control/interaction. Herein, the robot 100a can obtain intention information on interaction according to a user's behavior or voice input, and determine a response on the basis of the obtained intention information so as to perform operations.

The self-driving vehicle 100b can be employed as a movable robot, a vehicle, an unmanned flying robot, etc. by applying the AI technique thereto.

The self-driving vehicle 100b can include a self-driving control module controlling a self-driving function, and the self-driving control module can mean a software module or a chip where the same is employed in hardware. The self-driving control module can be included in the self-driving vehicle 100b as a component thereof, but can be connected to the self-driving vehicle 100b by being configured in separate hardware.

The self-driving vehicle 100b can obtain state information of the self-driving vehicle 100b, detect (recognize) a surrounding environment and objects, generate map data, determine a moving path and a driving plan, or determine operations by using sensor information obtained through various types of sensors.

Herein, in order to determine a moving path or driving plan, the self-driving vehicle 100b, similar to the robot 100a, can use sensor information obtained by using at least one sensor of a lidar, a radar, and a camera.

Particularly, the self-driving vehicle 100b can recognize an environment and objects for areas that are hidden from view or over a certain distance by receiving sensor information from external devices, or by receiving information directly recognized from the external devices.

The self-driving vehicle 100b can perform the above operations by using a learning model configured with at least one artificial neural network. For example, the self-driving vehicle 100b can recognize a surrounding environment and objects by using a learning model, and determine a driving path by using the recognized surrounding environment information or object information. Herein, the learning model can be obtained by directly performing learning by the self-driving vehicle 100b, or by performing learning by the external device such as an AI sever 200, etc.

Herein, the self-driving vehicle 100b can generate a result by directly using the learning model so as to perform operations. However, the self-driving vehicle 100b can transmit the sensor information to the external device such as an AI sever 200, and receive a result generated according thereto so as to perform operations.

The self-driving vehicle 100b can determine a moving path and a driving plan by using at least one map data, object information detected from the sensor information, and object information obtained from the external device, and drive according to the determined moving path and the driving plan by controlling a driving part.

Map data can include object identification information on various objects (for example, roads) arranged in a space where the self-driving vehicle 100b drives. For example, the map data can include object identification information on fixed objects such as street lamps, rocks, buildings, etc. and movable objects such as vehicles, pedestrians, etc. In addition, the object identification information can include a name, a type, a distance, a position, etc.

In addition, the self-driving vehicle 100b can perform operations or drive by controlling the driving part on the basis of the user's control/interaction. Herein, the self-driving vehicle 100b can obtain intention information on interaction according to a user's behavior or voice input, and determine a response on the basis of the obtained intention information so as to perform operations.

The XR device 100c can be employed by using a HIVID, a HUD provided in a vehicle, a TV, a mobile phone, a smart phone, a PC, a wearable device, a home appliance, a digital signage, a vehicle, or a fixed type robot or movable type robot.

The XR device 100c analyze 3D point cloud data or image data which is obtained through various sensors or external devices, generate position data and feature data on 3D points, and obtain information on a surrounding space and real objects and output XR objects to be rendered. For example, the XR device 100c can output XR objects including additional information on the recognized objects by reflecting the same in the corresponding recognized objects.

The XR device 100c can perform the above operations by using a learning model configured with at least one artificial neural network. For example, the XR device 100c can recognize real objects from 3D point cloud data or image data by using a learning model, and provide information in association with the recognized real objects. Herein, the learning model can be obtained by directly performing learning by the XR device 100c, or by performing learning by the external device such as an AI sever 200, etc.

Herein, the XR device 100c can generate a result by directly using the learning model so as to perform operations. However, the XR device 100c can transmit the sensor information to the external device such as an AI sever 200, and receive a result generated according thereto so as to perform operations.

The robot 100a can be employed in a guide robot, a transport robot, a cleaning robot, a wearable robot, an entertainment robot, a pet robot, an unmanned flying robot, etc. by applying the AI technique and the self-driving technique thereto.

The robot 100a to which the AI technique and the self-driving technique are applied can mean a robot itself with a self-driving function, or the robot 100a operating in conjunction with the self-driving vehicle 100b.

The robot 100a with the self-driving function can refer to all devices moving by itself according to a given movement, or by determining a moving path by itself without a user control.

The robot 100a and the self-driving vehicle 100b which respectively have self-driving functions can use a common sensing method for determining at least one of a moving path and a driving plan. For example, the robot 100a and the self-driving vehicle 100b which respectively have self-driving functions can determine a moving path or driving plan by using information sensed through a lidar, a radar, a camera, etc.

The robot 100a operating in conjunction with the self-driving vehicle 100b can be present separate from the self-driving vehicle 100b, while the robot 100a is internally or externally connected to the self-driving function of the self-driving vehicle 100b, or can perform operations in association with the driver of the self-driving vehicle 100b.

Herein, the robot 100a operating in conjunction with the self-driving vehicle 100b can obtain sensor information in place of the self-driving vehicle 100b so as to provide the information to the self-driving vehicle 100b, or obtain sensor information and generate surrounding environment information or object information so as to provide the information to the self-driving vehicle 100b, and thus control or supplement the self-driving function of the self-driving vehicle 100b.

Alternatively, the robot 100a operating in conjunction with the self-driving vehicle 100b can monitor a driver of the self-driving vehicle 100b, or control functions of the self-driving vehicle 100b by operating in conjunction with the driver. For example, when it is determined that the driver is drowsy, the robot 100a can activate the self-driving function of the self-driving vehicle 100b or control the driving part of the self-driving vehicle 100b. Herein, functions of the self-driving vehicle 100b which are controlled by the robot 100a include, in addition to the self-driving function, functions provided from a navigation system or audio system provided in the self-driving vehicle 100b.

Alternatively, the robot 100a operating in conjunction with the self-driving vehicle 100b can provide information or supplement functions of the self-driving vehicle 100b from the outside of the self-driving vehicle 100b. For example, the robot 100a can provide traffic information including signal information such as smart signals to the self-driving vehicle 100b, or can automatically connect to an electrical charging device such as an automatic electric charger of an electric vehicle by operating in conjunction with the self-driving vehicle 100b.

The robot 100a can be employed in a guide robot, a transport robot, a cleaning robot, a wearable robot, an entertainment robot, a pet robot, an unmanned flying robot, a drone, etc. by applying the AI technique and the XR technique thereto.

The robot 100a to which the XR technique is applied can mean a robot that becomes a target controlled/operated within an XR image. Herein, the robot 100a can be distinguished from the XR device 100c and operate in conjunction with the same.

For the robot 100a that becomes a target controlled/operated within an XR image, when sensor information is obtained from sensors including a camera, the robot 100a or the XR device 100c can generate an XR image on the basis of the sensor information, and the XR device 100c can output the generated XR image. In addition, the above robot 100a can operate on the basis of a control signal input through the XR device 100c, or in conjunction with the user.

For example, the user can check an XR image in association with a view of the robot 100a that is in conjunction with the external device such as XR device 100c in a remote manner, adjust a self-driving path of the robot 100a through in conjunction with the robot 100a, control operations or driving, or check information on surrounding objects.

The self-driving vehicle 100b can be employed in a movable robot, a vehicle, an unmanned flying robot, etc. by applying the AI technique and the XR technique thereto.

The self-driving vehicle 100b to which the XR technique is applied can mean self-driving vehicle provided with a device providing an XR image, and self-driving vehicle that becomes a target controlled/operated within an XR image, etc. Particularly, the self-driving vehicle 100b that becomes a target controlled/operated within an XR image can be distinguished from the XR device 100c, and operate in conjunction with the same.

The self-driving vehicle 100b provided with a device providing an XR image can obtain sensor information from sensors including a camera, and output an XR image generated on the basis of the obtained sensor information. For example, the self-driving vehicle 100b outputs an XR image by using a HUD, and thus provides to a passenger a real object or XR object in association with objects within a screen.

Herein, when the XR object is displayed on the HUD, at least a part of the XR object can be displayed to overlap the real object to which the passenger's eyes are directed. On the other hands, when the XR object displayed on a display included in the self-driving vehicle 100b, at least a part of the XR object can be displayed to overlap an object within the screed. For example, the self-driving vehicle 100b can output XR objects in association with carriageways, other vehicles, signals, traffic signs, motorcycles, pedestrians, buildings, etc.

For the self-driving vehicle 100b that becomes a target controlled/operated within an XR image, when sensor information is obtained from sensors including a camera, the self-driving vehicle 100b or XR device 100c can generate an XR image on the basis of the sensor information, and the XR device 100c can output the generated XR image. In addition, the above self-driving vehicle 100b can operate on the basis of a control signal input through the external device such as XR device 100c, etc. or in conjunction with the user.

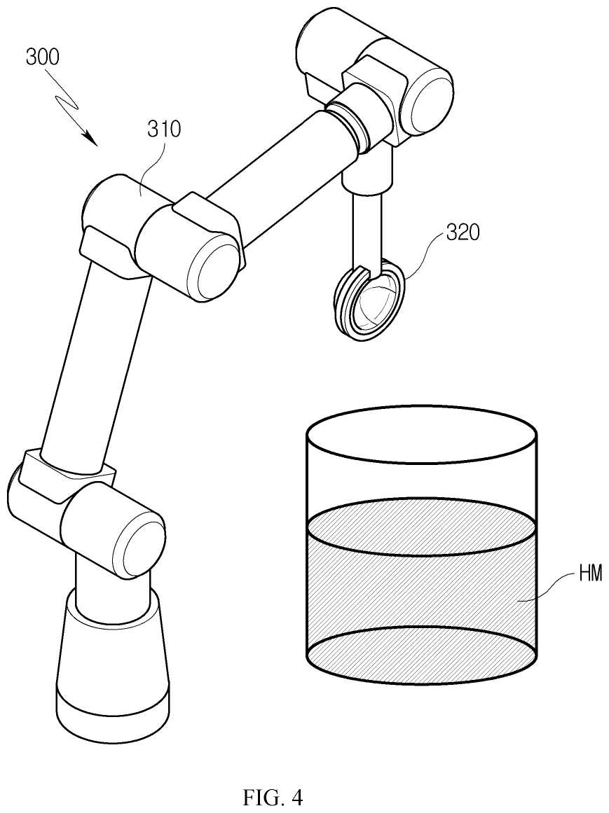

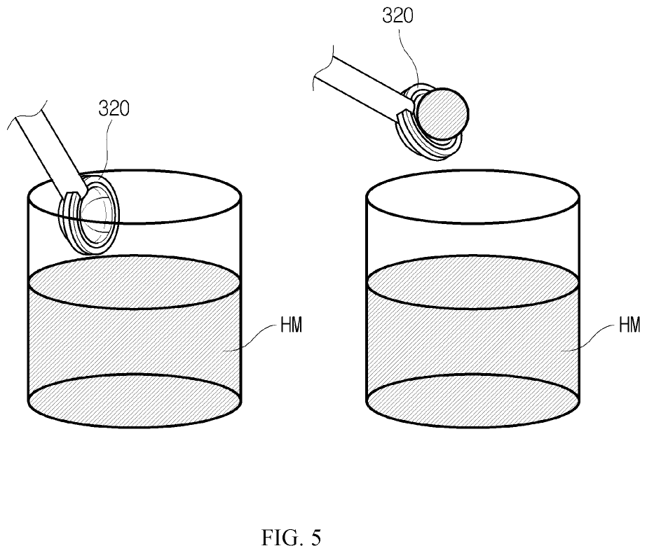

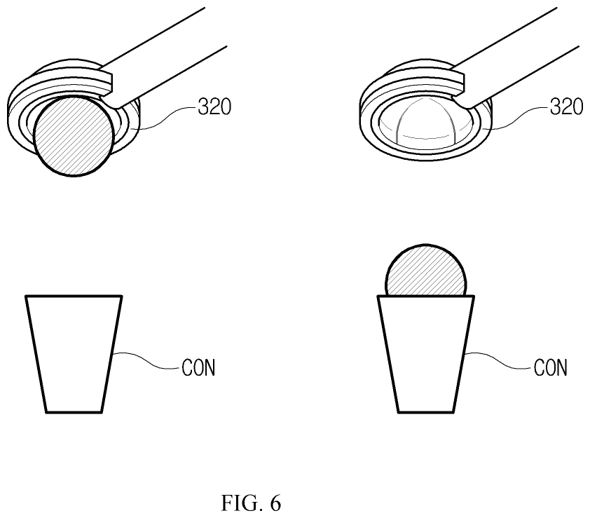

FIG. 4 is a view showing the robot according to embodiments of the present disclosure, and FIGS. 5 and 6 are views of examples respectively showing operations for the robot of FIG. 4. Referring to FIG. 4, a robot 300 can be configured to serve coagulated matter HM to a user by using a manipulator 310 and a scoop 320. The robot 300 shown in FIG. 4 can be configured to perform functions of the AI apparatus 100 described with reference to FIGS. 1 to 3, but it is not limited thereto. For example, the robot 300 can be configured to perform at least one of functions of the AI apparatus 100.

According to examples, the matter HM provided by the robot 300 can be matter where at least a part thereof is coagulated. For example, at least a part of the matter HM can be a solid state under an environment where the matter HM is provided. For example, the robot 300 can scoop out the matter HM where at least a part thereof is coagulated such as ice-cream, gelato, ice, etc., and provide the matter HM to the user.

The robot 300 can put the matter HM into the scoop 320 by moving the manipulator 310 in response to a serving start command, put the matter HM within the scoop 320 into a serving container, and provide the serving container with the matter HM to the user.

The robot 300 can include the manipulator 310 and the scoop 320.

The manipulator 310 can be configured to perform mechanical operations. According to examples, the manipulator 310 can be an articulated robotic arm that includes at least one joint, a link, a gear, etc. which perform various operations. According to examples, the manipulator 310 can move in six-degree-of-freedom motion at an end thereof. The manipulator 310 can be a robot arm including a plurality of joints and a plurality of links connected with each other through the plurality of joints. According to examples, a driving motor can be included in each of the plurality of joints, and each driving motor can operate according to a control of a controller 370 so as to control movement of the manipulator 310.

The scoop 320 can be a tool for scooping out the matter HM. The manipulator 310 can control the scoop 320 to move. According to examples, the scoop 320 can be combined with the manipulator 310. For example, the scoop 320 can be installed in an end (for example, end effector of the robot arm) of the manipulator 310, and move with the manipulator 310, but it is not limited thereto. The scoop 320 can be separated from the manipulator 310 and move according to a control of the manipulator 310. Accordingly, in the present specification, moving the scoop 320 by the manipulator 310 includes that the manipulator 310 moves with the scoop 320, as well as, separately moving the scoop 320 according to a control of the manipulator 310.

The robot 300 can perform a moving operation of moving the manipulator 310 and the scoop 320, a scooping operation of putting the matter HM into the scoop 320 by using the manipulator 310, and a release operation of putting the matter HM within the scoop 320 into a serving container.

In the present specification, a moving operation can mean moving, by the robot 300, the manipulator 310 and the scoop 320. During the moving operation, the robot 300 can control movements of the manipulator 310 and the scoop 320. According to examples, the robot 300 can move the manipulator 310 and the scoop 320 to specific coordinates, or rotate the manipulator 310 and the scoop 320 around a specific angle. For example, the robot 300 can move the manipulator 310 and the scoop 320 to a position close to the matter HM or serving container.

In the present specification, a scooping operation can mean putting the matter HM into the scoop 320. As shown in FIG. 5, during the scooping operation, the robot 300 can put the matter HM into the scoop 320 by using the scoop 320. According to examples, the robot 300 can put the matter HM into the scoop 320 through translating or rotating the scoop 320. For example, the robot 300 can scrape off a surface of the matter HM by using the scoop 320, push the scoop 320 into the matter HM, and put the matter HM into the scoop 320 by rotating and moving the scoop 320, but it is not limited thereto.

In the present specification, a release operation can mean moving, by the robot 300, the matter within the scoop 320 to another place (for example, serving container, etc.). In other words, the release operation means all operations of releasing the matter HM within the scoop 320 from the scoop 320. As shown in FIG. 6, during the release operation, the robot 300 can move the matter HM within the scoop 320 to a serving container CON. According to examples, the robot 300 can move the matter HM from the scoop 320 to the serving container CON by translating or rotating the scoop 320. For example, during the release operation, the robot 300 can flip the scoop 320 by rotating the scoop 320 around a handle 327 of the scoop 320. In addition, the robot 300 can perform the release operation above the serving container CON by shaking the scoop 320, but it is not limited thereto.

The moving operation can be performed before and after the scooping operation and the release operation.

The robot 300 can perform a scooping operation, perform a release operation after the scooping operation, and perform again a scooping operation when the release operation is completed. In other words, the robot 300 may not perform a release operation when a scooping operation is not performed. According to example, the robot 300 can perform a release operation when a scooping operation is completed.

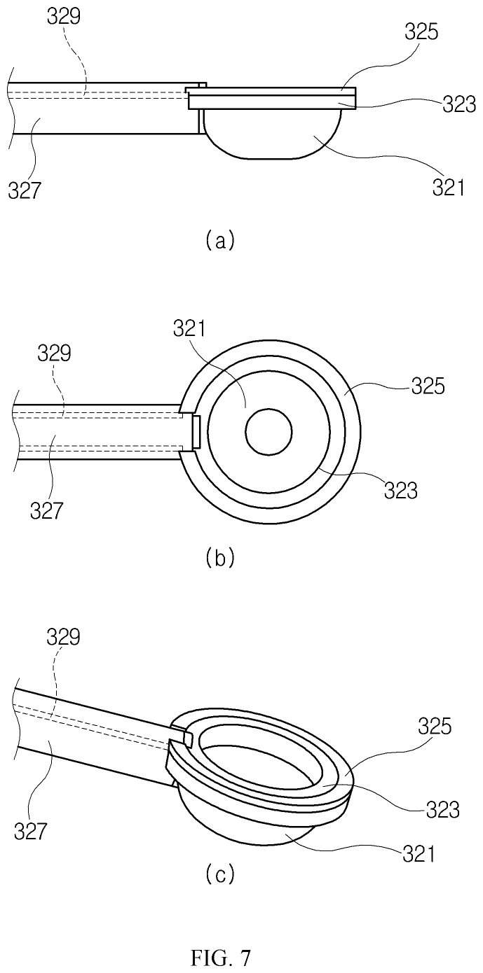

FIG. 7 is a view showing a scoop according to embodiments of the present disclosure. Referring to FIG. 7, the scoop 320 can include a first part 321, a second part 323, a temperature adjusting element 325, a handle 327, and a power supply line 329.

The first part 321 of the scoop 320 can mean a part through which the matter (or material) HM passes, and the second part 323 can mean a part where the matter HM having passed the first part 321 is received (or included). According to examples, as a result of a scooping operation of the robot 300, the matter HM can be received in the second part 323 by passing the first part 321 of the scoop 320, and as a result of a release operation of the robot 300, the matter HM can be put into a container from the second part 323 by passing through the first part 321.

The first part 321 can include an opening part through which the matter HM passes. For example, the first part 321 can be formed in a ring form including an opening.

The second part 323 can be formed in a dome shape or hemisphere shape to effectively receive the matter HM, but is not limited thereto. When the second part 323 is formed in a dome shape or hemisphere shape, the first part 321 can be formed in a ring shape disposed on a circumferential edge of the dome or hemisphere.

The first part 321 can be formed along an edge of the second part 323. According to examples, the first part 321 can include an opening formed along an upper circumferential edge of the second part 323. For example, the first part 321 can be a rim of the second part 323.

According to examples, the first part 321 and the second part 323 can include conductive material. For example, the first part 321 and the second part 323 can include metal.

The temperature adjusting element 325 can change temperature according to a signal (for example, voltage signal) input from the outside. According to examples, the temperature adjusting element 325 can emit heat (that is, increase in temperature) or absorb heat (that is, decrease in temperature).

The temperature adjusting element 325 can be disposed close to the first part 321 and the second part 323. According to examples, the temperature adjusting element 325 can be in contact with the first part 321 and the second part 323. For example, the temperature adjusting element 325 can be disposed between the first part 321 and the second part 323, but it is not limited thereto.

The temperature adjusting element 325 can form a boundary of the scoop 320 with the first part 321. According to examples, the temperature adjusting element 325 can take a form of a circle or an arc. For example, the temperature adjusting element 325 can be disposed along an outer circumference of the first 321, and disposed on the second part 323.

Accordingly, by adjusting temperature of the temperature adjusting element 325, the first part 321 and the second part 323 also change in temperature, and thus the scoop 320 can change in temperature.

For example, the temperature adjusting element 325 can be a thermoelectric element including a Peltier element. The thermoelectric element changes in temperature when a voltage is supplied thereto. For example, the temperature adjusting element 325 can include a heat absorbing surface that absorbs heat from the outside and a heat emitting surface that emits heat to the outside. The heat absorbing surface and the heat emitting surface can operate complementarily. For example, the temperature adjusting element 325 can absorb heat through the heat absorbing surface or emit heat through the heat emitting surface when a voltage is supplied thereto.

The handle 327 can extend from the first part 321 or the second part 323. The handle 327 can have a form of a column extending from the first part 321 or second part 323 so as to facilitate manipulation of scoop 320. According to examples, the handle 327 can be connected to the manipulator 310 of the robot 300.

The power supply line 329 can transfer a power source (voltage or current) supplied thereto to the scoop 320. For example, the power supply line 329 can mean a conductive wire, but it is not limited thereto. According to examples, the power supply line 329 can be connected to the temperature adjusting element 325 by being disposed within the handle 327. For example, the power supply line 329 can be connected to the temperature adjusting element 325 by passing through the inside of the handle 327 while not being exposed to the outside.

Accordingly, the power source supplied thereto can be transferred to the temperature adjusting element 325 through the inside of the handle 327.

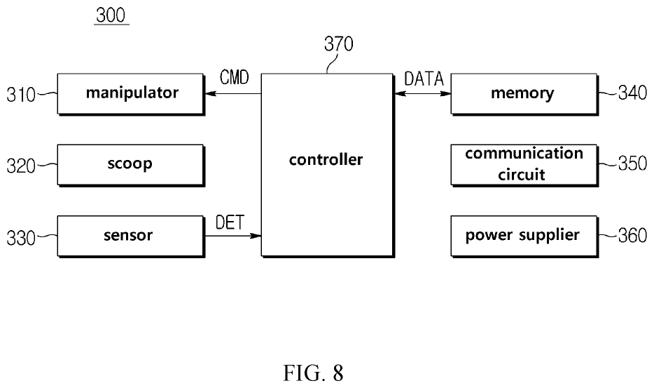

FIG. 8 is a view conceptually showing the robot according to embodiments of the present disclosure. Referring to FIGS. 4 to 8, the robot 300 can further include a sensor 330, a memory 340, a communication circuit 350, a power supplier 360, and a controller 370. Meanwhile, although the controller 370 is included in the robot 300 in FIG. 5, according to examples, the controller 370 can be present in the outside of the robot 300. For example, the controller 370 can mean a server performing communication with the robot 300.

The sensor 330 can be configured to obtain information on an environment of the robot 300. According to examples, the sensor 330 can perform a sensing function by being included in the manipulator 310 or scoop 320.

The sensor 330 can include at least one of a force/torque sensor measuring external force values applied to the manipulator 310 or scoop 320, a temperature sensor measuring a temperature value of the manipulator 310 or scoop 320, an angular sensor measuring a rotation angle of the manipulator 310 or scoop 320, and a camera obtaining an image of a surrounding environment.

For example, the force/torque sensor can measure force and torque values applied to each axis on a space (for example, 3-axis or 6-axis), and output a detection signal indicating the measured force and torque values. For example, the temperature sensor can measure a temperature value, and output a detection signal indicating the measured temperature value. For example, the angular sensor can measure a bias angle with respect to a reference angle, and output a detection signal indicating the measured angle.

The sensor 330 can transmit the measurement result according to a sensing operation to the manipulator 310 or controller 370.

The memory 340 can be for storing data required for operating the robot 300. According to examples, the memory 340 can include at least one of a non-volatile memory device and a volatile memory device.

The communication circuit 350 can perform communication between the robot 300 and another device. According to examples, the communication circuit 350 can transmit data from the robot 300 to another device, or receive data transmitted from another device to the robot 300. For example, the communication circuit 350 can perform communication by using a wireless network or wired network.

The power supplier 360 can be configured to supply a power source required for operating the robot 300. According to examples, the power supplier 360 can supply a power source to each component of the robot 300 according to a control of the controller 370. For example, the power supplier 360 can include at least one of a battery, a DC/AC converter, an AC/DC converter, an AC/AC converter, and an inverter.

The controller 370 can be configured to control the overall operation of the robot 300. According to examples, the controller 370 can control operations of the manipulator 310, the scoop 320, the sensor 330, the memory 340, the communication circuit 350, and the power supplier 360. According to examples, the controller 370 can include a processor having a calculation processing function. For example, the controller 370 can include a calculation processing device such as CPU (central processing unit), MCU (micro computer unit), GPU (graphics processing unit), etc., but it is not limited thereto.

The controller 370 can control operations of the manipulator 310. According to examples, the controller 370 can perform communication with the manipulator 310 through wired or wireless communication, and transmit a command CMD indicating various operations to the manipulator 310.

The command CMD transmitted from the controller 370 to the manipulator 310 can include a moving command, a rotation command, and a manipulation command. The controller 370 can transmit a command CMD to the manipulator 310, and the manipulator 310 can perform an operation on the basis of the command CMD transmit from the controller 370. According to examples, the controller 370 can transmit to the manipulator 310 a command CMD for performing an operation corresponding to each step of a workflow on the basis of the workflow including a series of operations to be performed by the robot 300. The workflow can be generated and stored in advance. The workflow of the robot 300 can include at least one of a moving operation, a scooping operation, and a release operation. The controller 370 can load the workflow, and determine which operation is to be performed currently by the robot 300 on the basis of the workflow. In addition, the controller 370 can determine whether the operation to be performed currently by the robot 30 is a moving operation, a scooping operation, or a release operation.

When a moving operation has to be performed, the controller 370 can transmit a moving operation command to the manipulator 310 on the basis of a workflow of the robot 300, and the manipulator 310 can move the scoop 320 in response to the moving operation command transmitted from the controller 370. According to examples, the manipulator 310 can move the scoop 320 so that coordinates (for example, coordinates on a 3D space) of the scoop 320 become close to coordinates of the matter HM. Information on the above coordinates can be stored in the memory 340. In addition, the robot 300 can rotate the manipulator 310 and the scoop 320 to a position close to the matter HM. For example, the robot 300 can rotate the scoop 320 so that a distance between the scoop 320 and the matter HM becomes minimum.

When a scooping operation has to be performed, the controller 370 can transmit a scooping operation command to the manipulator 310 on the basis of a workflow of the robot 300, and the manipulator 310 can perform a scooping operation in response to the scooping operation command transmitted from the controller 370. According to examples, the manipulator 310 can put the matter HM into the scoop 320 by translating or rotating the scoop 320. For example, the manipulator 310 can scrape off a surface of the matter HM by using the, push the scoop 320 into the matter HM, and put the matter HM into the scoop 320 by rotating the scoop 320, but it is not limited thereto.

When a release operation has to be performed, the controller 370 can transmit a release operation command to the manipulator 310 on the basis of a workflow of the robot 300, and the manipulator 310 can perform a release operation in response to the release operation command transmitted from the controller 370. According to examples, the manipulator 310 can put the matter HM into the serving container by translating or rotating the scoop 320. For example, the manipulator 310 can perform a release operation above the serving container CON by shaking the scoop 320, but it is not limited thereto.

The controller 370 can control temperature of the scoop 320. According to examples, the controller 370 can control temperature of the scoop 320 by controlling temperature of the temperature adjusting element 325. For example, when the temperature adjusting element 325 is a thermoelectric element, the controller 370 can control temperature of the temperature adjusting element 325 by controlling a voltage supplied to the temperature adjusting element 325. In other words, the controller 370 can turn on/off a switch between the temperature adjusting element 325 and the power supplier, or control the supply of the voltage to the temperature adjusting element 325.

The controller 370 can increase temperature of the second part 323 of the scoop 320, or increase temperature of the first part 321 of the scoop 320 by controlling the temperature adjusting element 325. According to examples, the controller 370 can transmit a first temperature adjusting command to the temperature adjusting element 325 so as to adjust temperature of the first part 321 of the scoop 320, and transmit a second temperature adjusting command to the temperature adjusting element 325 so as to adjust temperature of the second part 323 of the scoop 320.

For example, when the temperature adjusting element 325 is a thermoelectric element, the controller 370 can increase temperature of the first part 321 of the scoop 320 by supplying a first voltage to the temperature adjusting element 325, and increase temperature of the second part 323 by supplying to the temperature adjusting element 325 a second voltage in a direction opposite to the first voltage.

According to examples, when a scooping operation is ongoing or has to be performed by the manipulator 310, the controller 370 can increase temperature of the first part 321, and when a release operation is ongoing or has to be performed by the manipulator 310, the controller 370 can increase temperature of the second part 323. For example, when a scooping operation has to be performed, temperature of the first part 321 of the scoop 320 which is in contact with the matter HM has to be increased so as to melt a surface of the matter HM. On the other hand, when a release operation has to be performed, temperature of the second part 323 of the scoop 320 has to be increased where the matter HM is received.

According to the robot 300 according to embodiments of the present disclosure, when the surface of the matter HM is in a coagulated state when performing a scooping operation, temperature of the first part 321 of the scoop 320 is increased, and thus the matter HM can be scooped of with less force. When temperature of the second part 323 of the scoop 320 is increased during a release operation, the matter HM can easily move from the scoop 320 to the serving container. Controlling temperature of the scoop 320 by the controller 370 will be described later.

The controller 370 can receive a detection signal DET from the sensor 330. According to examples, the controller 370 can receive a detection signal DET measured by the sensor 330 while the robot 300 is in operation. For example, the detection signal DET can be a signal representing external force applied to the manipulator 310 while the robot 300 is in operation.

The controller 370 can control operations of the robot 300 in response to the detection signal DET transmitted from the sensor 330. According to examples, the controller 370 can adjust temperature of the scoop 320 on the basis of a detection signal DET transmitted from the sensor 330.

The controller 370 can control operations of the memory 340. According to examples, the controller 370 can load data DATA from the memory 340, or write data DATA in the memory. For example, the controller 370 can load workflow data of the robot 300, position or time data required for operating the robot 300 from the memory 340.

The controller 370 can control operations of the communication circuit 350. According to examples, the controller 370 can control communication between the communication circuit 350 and the outside. For example, the communication circuit 350 can transmit data to the outside, or receive data from the outside according to a control of the controller 370. According to examples, the controller 370 can control the robot 300 on the basis of the external command transferred through the communication circuit 350. The external command can be input from the user.

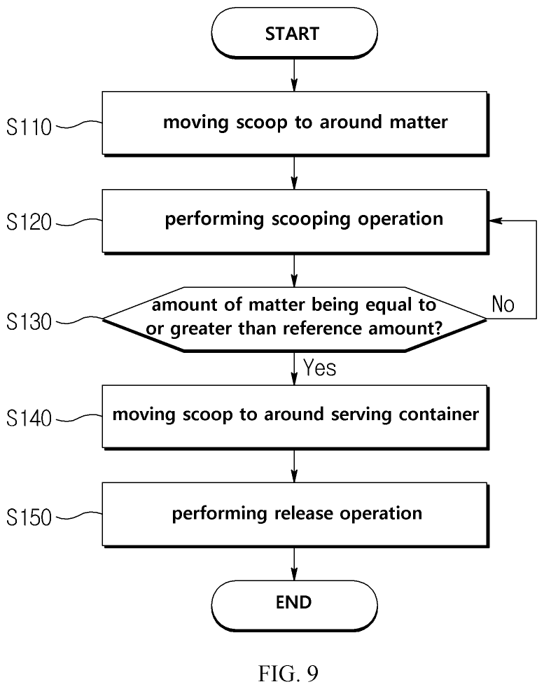

FIG. 8 is a view of a flowchart showing an operation method of the robot according to embodiments of the present disclosure. The operation method of the robot described with reference to FIG. 9 can be performed by the robot 300 (for example, controller 370) described with reference to FIGS. 1 to 6. Referring to FIG. 9, in S110, the robot 300 can move the scoop 320 around the matter HM. According to examples, the controller 370 can transmit a moving command to the manipulator 310 so as to move the scoop 320 to around the matter HM, and the manipulator 310 can move the scoop 320 to around the matter HM according to a control of the controller 370. Information on coordinates of the matter HM can be stored in the memory 340.

In S120, the robot 300 can perform a scooping operation after moving the scoop 320. According to examples, the controller 370 can transmit a scooping operation command to the manipulator 310⁰∥ so as to perform a scooping operation, and the manipulator 310 can perform a scooping operation according to a control of the controller 370.

In S130, the robot 300 can determine whether or not an amount of the matter HM within the scoop 320 is equal to or greater than a reference amount. According to examples, the robot 300 can measure a weight value of the matter HM within the scoop 320 by using the sensor 330, and determine whether or not an amount of the matter HM is equal to or greater than a reference amount on the basis of the measured weight value.

The robot 300 can measure an external force value applied to the manipulator 310 or scoop 320 by using the sensor 330, and determine whether or not an amount of the matter HM is equal to or greater than a reference amount on the basis of the measured external force value. For example, the robot 300 can determine whether or not an amount of the matter HM is equal to or greater than a reference amount on the basis of the measured external force value and the weight value of the scoop 320. The weight value of the matter HM within the scoop 320 can be based on an amount of the matter HM, and the weight value of the matter HM can be based on the external force applied to the manipulator 310 or scoop 320.

When an amount of the matter HM within the scoop 320 is equal to or greater than a reference amount (i.e., the answer to step S130 is “Yes”), in S140, the robot 300 can move the scoop 320 to around the serving container. According to examples, the controller 370 can transmit a moving command to the manipulator 310 so as to move the scoop 320 around the serving container, and the manipulator 310 can move the scoop 320 to around the serving container according to a control of the controller 370. Information on coordinates of the serving container can be stored in the memory 340. On the other hand, when an amount of the matter HM within the scoop 320 is not equal to or greater than a reference amount (i.e., the answer to step S130 is “No”), the robot 300 can perform again a scooping operation.

In S150, the robot 300 can perform a release operation. According to examples, the controller 370 can transmit a scooping operation command to the manipulator 310 so as to perform a release operation, and the manipulator 310 can perform a release operation according to a control of the controller 370.

The robot 300 according to embodiments of the present disclosure can put (scooping operation) the matter HM into the scoop 320 by using the scoop 320 installed in the robot 300, and put the matter HM into the serving container (release operation) when an amount of the matter HM within the scoop 320 is equal to or greater than a certain amount.

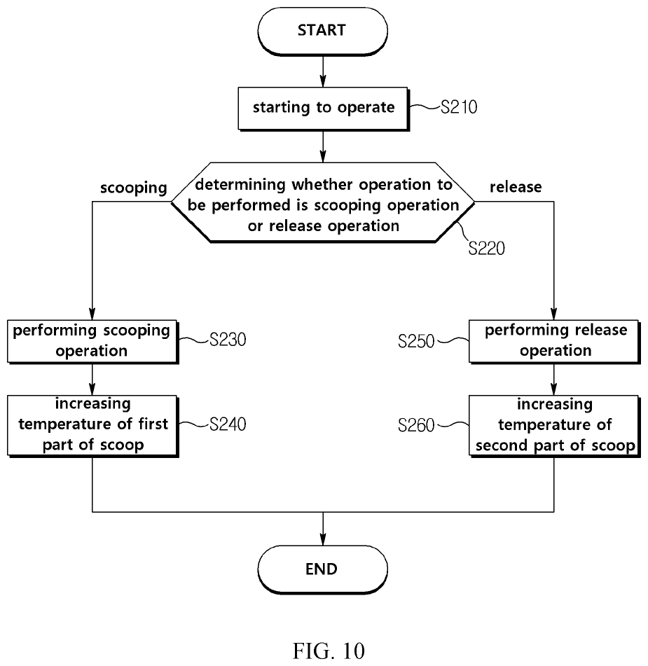

FIG. 10 is a view of a flowchart showing an operation method of the robot according to embodiments of the present disclosure. The operation method of the robot described with reference to FIG. 10 can be performed by the robot 300 (for example, controller 370) described with reference to FIGS. 1 to 6. Referring to FIGS. 1 to 10, in S210, the robot 300 can start to operate. According to examples, the robot 300 can start to operate according to a start command from the outside.

In S220, the robot 300 can determine whether an operation to be performed is a scooping operation or a release operation. According to examples, the controller 370 can determine whether an operation to be performed is a scooping operation or a release operation on the basis of a loaded workflow.

According to the determination result, in S230, the robot 300 can perform a scooping operation. According to examples, the controller 370 can transmit a scooping operation command to the manipulator 310, and the manipulator 310 can perform a scooping operation according to a control of the controller 370.

During the scooping operation, in S240, the robot 300 can increase temperature of the first part 321 of the scoop 320. According to examples, the controller 370 can control temperature of the temperature adjusting element 325 by supplying a voltage to the temperature adjusting element 325, and as the temperature adjusting element 325 changes in temperature, temperature of the first part 321 close to the temperature adjusting element 325 is also increased. For example, when the temperature adjusting element 325 is a thermoelectric element, the controller 370 can control the temperature adjusting element 325 so that the temperature of the temperature adjusting element 325 is increased on a surface that is in contact with the first part 321 among surfaces of the temperature adjusting element 325.

When the temperature of the first part 321 is increased, temperature of the matter HM close to the first part 321 is also increased. As the temperature of the matter HM is increased, at least a part of the coagulated matter HM becomes melted. Accordingly, external force required for scooping out the matter HM can be reduced. Accordingly, according to examples of the present disclosure, the matter HM can be easily scooped of by controlling the temperature of the scoop 320.

According to the determination result, in S250, the robot 300 can perform a release operation. According to examples, the controller 370 can transmit a release operation command to the manipulator 310, and the manipulator 310 can perform a release operation according to a control of the controller 370.

The controller 370 can perform a release operation when the scooping operation has completed. According to examples, the controller 370 can recognize that the scooping operation has completed by the manipulator 310, and control the manipulator 310 so as to perform a release operation after checking that the scooping operation has completed. For example, the controller 370 can transmit a release operation command to the manipulator 310 when a completion command of the scooping operation is received from the manipulator 310.

During the release operation, in S260, the robot 300 can increase temperature of the second part 323 of the scoop 320. According to examples, the controller 370 can control temperature of the temperature adjusting element 325 by supplying a voltage to the temperature adjusting element 325. As the temperature adjusting element 325 changes in temperature, temperature of the second part 323 close to the temperature adjusting element 325 is also increased. For example, when the temperature adjusting element 325 is a thermoelectric element, the controller 370 can control the temperature adjusting element 325 so that temperature of a surface that is in contact with the second part 323 is increased among surfaces of the temperature adjusting element 325. Herein, among surfaces of the temperature adjusting element 325, temperature of a surface that is in contact with an edge portion is decreased.

When the temperature of the second part 323 is increased, temperature of the matter HM close to the second part 323 is also increased. As the temperature of the matter HM is increased, a part of the matter HM within the second part 323 becomes melted. Accordingly, the matter HM can be easily moved from the scoop 320 to the serving container, and thus time to the release operation can be reduced.

According to examples, the robot 300 can decrease temperature of the second part 323 of the scoop 320 when an operation to be performed is neither a scooping operation nor a release operation. For example, the robot 300 can decrease temperature of the second part 323 of the scoop 320 when a moving operation is performed. Accordingly, the matter HM within the scoop 320 can maintain a frozen state.

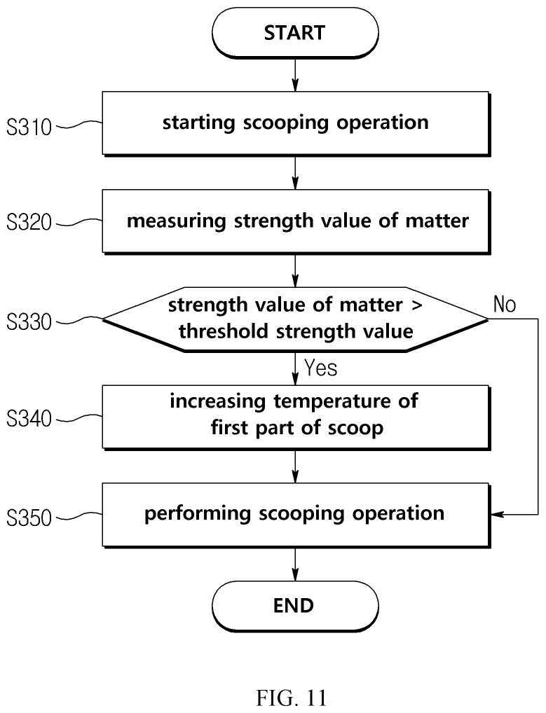

FIG. 11 is a view of a flowchart showing an operation method of the robot according to embodiments of the present disclosure. The operation method of the robot described with reference to FIG. 11 can be performed by the robot 300 (for example, controller 370) described with reference to FIGS. 1 to 6. Referring to FIGS. 1 to 11, in S310, the robot 300 starts a scooping operation for scooping out the matter HM. According to examples, the robot 300 can determine whether or not to start a scooping operation on the basis of a loaded workflow, and start a scooping operation. For example, the robot 300 can start a scooping operation by loading a workflow including a scooping operation in response to a start request of a user.

In S320, the robot 300 can measure a strength value of the matter HM during the scooping operation. According to examples, the robot 300 can measure a strength value of the matter HM by measuring an external force value applied to the manipulator 310 or scoop 320 through operation in conjunction with the matter HM by using the sensor 330 during the scooping operation. For example, the controller 370 can obtain an external force value on the basis of a detection signal DET transmitted from the sensor 330.

In S330, the robot 300 can determine whether or not the strength value of the matter HM exceeds a threshold strength value. According to examples, the controller 370 can determine whether or not an external force value applied to the manipulator 310 or scoop 320 during the scooping operation exceeds a threshold external force. Herein, the threshold external force can mean the maximum force (or torque) that the robot 300 (or manipulator 310) can output, or the maximum external force that the robot 300 can withstand, and can be stored in the memory 340.

When the strength value of the matter HM is high, the measured external force value during the scooping operation can be high. In other words, when the measured external force value during the scooping operation exceeds the threshold external force value that the robot 300 (or manipulator 310) can withstand, a failure can occur in the robot 300.

In S340, the robot 300 can increase temperature of the first part 321 of the scoop 320 when the strength value of the matter HM exceeds the threshold strength value (i.e., the answer to step S330 is “Yes”). According to examples, when the applied external force value exceeds the threshold external force value during the scooping operation, the controller 370 can control temperature of the temperature adjusting element 325 so as to increase temperature of the first part 321 of the scoop 320.

According to examples, the robot 300 can increase temperature of the first part 321 of the scoop 320 until the measured external force value becomes smaller than the threshold external force value. For example, the robot 300 can increase temperature of the first part 321 of the scoop 320 until the measured external force value becomes smaller than half of the threshold external force value.

In addition, the robot 300 can stop increasing temperature of the first part 321 when the temperature of the first part 321 of the scoop 320 exceeds a certain level. According to examples, the temperature of the first part 321 can be measured through a temperature sensor included in the robot 300.

In S350, after increasing temperature of first part 321, the robot 300 can perform a scooping operation. When the temperature of the first part 321 is increased, temperature of the matter HM close to the first part 321 is also increased. As the temperature of the matter HM is increased, at least a part of the coagulated matter HM becomes melted. Accordingly, external force required for scooping out the matter HM is reduced as the strength of the matter HM is decreased. Accordingly, according to examples of the present disclosure, the matter HM can be easily scooped of by controlling the temperature of the scoop 320.

According to examples, when the strength of the matter HM exceeds the threshold strength, the robot 300 can stop the scooping operation, and restart the scooping operation when the strength of the matter HM becomes smaller than the threshold strength.

In S350, the robot 300 can perform a scooping operation when the strength value of the matter HM does not exceed the threshold strength value (i.e., the answer to step S330 is “No”). According to examples, when the measure external force value during the scooping operation does not exceed the threshold external force value, the controller 370 can perform the scooping operation without increasing temperature in the edge portion.

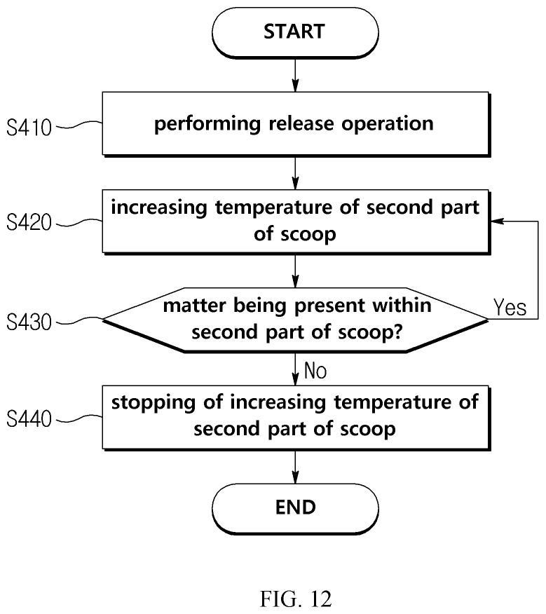

FIG. 12 is a view of a flowchart showing an operation method of the robot according to embodiments of the present disclosure. The operation method of the robot described with reference to FIG. 12 can be performed by the robot 300 (for example, controller 370) described with reference to FIGS. 1 to 6. Referring to FIGS. 1 to 12, in S410, the robot 300 can perform a release operation. According to examples, the robot 300 can determine whether or not to start a release operation on the basis of a loaded workflow, and start a release operation. For example, the robot 300 can load a workflow including a release operation in response to a start request of a user, and start a release operation.

In S420, the robot 300 can increase temperature of the second part 323 of the scoop 320 when the release operation is performed. According to examples, when the release operation is performed, the controller 370 can control temperature of the temperature adjusting element 325 so as to increase the temperature of the second part 323 of the scoop 320. When the temperature of the second part 323 is increased, temperature of the matter HM close to the second part 323 is also increased. As the temperature of the matter HM is increased, at least a part of the coagulated matter HM becomes melted. The melted matter HM is easily separated from the scoop 320, and thus the release operation is easily performed. Accordingly, time to the release operation or power consumption thereof can be reduced.

In S430, the robot 300 can determine whether or not the matter HM is present in the scoop 320. According to examples, the controller 370 can determine whether or not the matter HM is present in the scoop 320 by measuring an external force value applied to the manipulator 310 or scoop 320 during the release operation. When the matter HM is present within the second part 323 (i.e., the answer to step S430 is “Yes”), an external force value applied to the second part 323 is increased, and thus the external force value can be a reference representing whether or not the matter HM is present. For example, the controller 370 can determine whether or not the matter HM is present within the second part 323 by comparing the measured applied external force value with reference force value during the release operation.

In S440, the robot 300 can stop increasing temperature of the second part 323 of the scoop 320 when the matter HM is not present within the second part 323 (i.e., the answer to step S430 is “No”). According to examples, when the matter HM is not present within the second part 323, the controller 370 can stop adjusting temperature of the temperature adjusting element 325 such that the temperature of the second part 323 of the scoop 320 is not increased. For example, the controller 370 can stop supplying a voltage to the temperature adjusting element 325. On the other hand, when the matter HM is present within the second part 323, the robot 300 can continue the operation of increasing temperature of the second part 323.

In addition, when the matter HM is not present within the second part 323, the robot 300 can complete (or end) the release operation. According to examples, robot 300 can restart a scooping operation after completing the release operation.

The operation method of the robot or operation method of the controller according to embodiments of the present disclosure can be stored in a computer readable storage medium so as to be employed in commands executable by the processor.

The storage medium can include a database, including distributed, such as a relational database, a non-relational database, an in-memory database, or other suitable databases, which can store data and allow access to such data via a storage controller, whether directly and/or indirectly, whether in a raw state, a formatted state, an organized stated, or any other accessible state. In addition, the storage medium can include any type of storage, such as a primary storage, a secondary storage, a tertiary storage, an off-line storage, a volatile storage, a non-volatile storage, a semiconductor storage, a magnetic storage, an optical storage, a flash storage, a hard disk drive storage, a floppy disk drive, a magnetic tape, or other suitable data storage medium.

Although some embodiments have been disclosed above, it should be understood that these embodiments are given by way of illustration only, and that various modifications, variations, and alterations can be made without departing from the spirit and scope of the present disclosure. Therefore, the scope of the present invention should be limited only by the accompanying claims and equivalents thereof.

What is claimed is:

1. A robot comprising:
a manipulator configured to perform movement;
a scoop connected to the manipulator, and configured to receive matter therein; and
a controller configured to control the robot,
wherein the controller is further configured to increase a temperature of a first part of the scoop when the robot performs a scooping operation of moving the scoop into the matter.

2. The robot of claim 1, wherein the controller increases the temperature of the first part when a strength value of the matter measured during the scooping operation exceeds a threshold strength value.

3. The robot of claim 2, further comprising a sensor configured to measure an external force value applied to the robot to measure the strength value of the matter,
wherein the controller determines whether the strength value of the matter exceeds the threshold strength value by determining whether the external force value applied to the robot during the scooping operation exceeds a threshold external force value.

4. The robot of claim 2, wherein the controller is further configured to:
stop the scooping operation when the strength value of the matter measured during the scooping operation exceeds the threshold strength value, and
restart the scooping operation when the strength value of the matter measured during the scooping operation becomes less than the threshold strength value.

5. The robot of claim 1, wherein the controller is further configured to increase a temperature of a second part of the scoop when the robot performs a release operation of moving the matter within the scoop to a serving container.

6. The robot of claim 5, wherein the controller is further configured to:
determine whether or not the matter is present within the second part of the scoop during the release operation, and
when the matter is not present in the second part of the scoop, stop increasing the temperature of the second part.

7. The robot of claim 6, further comprising a sensor configured to measure an external force value applied to the robot,
wherein the controller is further configured to determine whether or not the matter is present within the second part by comparing the external force value applied to the robot with a reference external force value during the release operation.

8. The robot of claim 5, wherein the controller is further configured to decrease the temperature of the second part when the robot performs a moving operation of moving the scoop.

9. The robot of claim 5, wherein the scoop further includes a thermoelectric element disposed adjacent to the first part and the second part,
wherein the robot further includes a power supplier supplying a power source, and
wherein the controller is further configured to:
control the power supplier to supply a first voltage to the thermoelectric element when the robot performs the scooping operation, and
control the power supplier to supply a second voltage to the thermoelectric element when the robot performs the release operation, the second voltage being applied in direction opposite to a direction of the first voltage.

10. The robot of claim 5, wherein the controller is further configured to:
control the robot to perform the release operation when an amount of the matter within the scoop is equal to or greater than a reference amount after the scooping operation is performed, and
control the robot to re-perform the scooping operation when the amount of the matter within the scoop is less than the reference amount.

11. A method of operating a robot including a manipulator and a scoop for receiving matter therein, the method comprising:
receiving a start command at the robot;
moving the scoop to around the matter in response to the start command;
performing a scooping operation of scooping the matter by using the scoop; and
increasing a temperature of a first part of the scoop when performing the scooping operation.

12. The method of claim 11, wherein the increasing of the temperature of the first part includes:
increasing the temperature of the first part when a strength value of the matter measured during the scooping operation exceeds a threshold strength value.

13. The method of claim 12, wherein the increasing of the temperature of the first part further includes:
measuring an external force value applied to the robot during the scooping operation; and
determining whether the strength value of the matter exceeds the threshold strength value by determining whether the external force value applied to the robot exceeds a threshold external force value.

14. The method of claim 12, further comprising:
stopping the scooping operation when the strength value of the matter measured during the scooping operation exceeds the threshold strength value; and
restarting the scooping operation when the strength value of the matter measured during the scooping operation becomes less than the threshold strength value.

15. The method of claim 11, further comprising:
moving the scoop to around a serving container after the scooping operation;
performing a release operation of placing the matter within the scoop into the serving container; and
increasing a temperature of a second part of the scoop when performing the release operation.

16. The method of claim 15, further comprising:
decreasing the temperature of the second part of the scoop when the robot performs a moving operation of moving the scoop.

17. The method of claim 15, wherein the scoop further includes a thermoelectric element disposed adjacent to the first part and the second part,
the increasing of the temperature of the first part includes supplying a first voltage to the thermoelectric element when performing the scooping operation, and
the increasing of the temperature of the second part includes supplying a second voltage to the thermoelectric element when performing the release operation, the second voltage being applied in direction opposite to a direction of the first voltage.

18. A scoop for receiving matter, the scoop comprising:
a first part through which the matter passes;
a second part in which the matter having passed the first part is received;
a temperature adjusting element disposed adjacent to the first part and the second part, temperature of the temperature adjusting element being adjusted by an external power source; and
a power supply line configured to transfer the external power source to the temperature adjusting element.

19. The scoop of claim 18, wherein the first part is disposed along an upper circumferential edge of the second part, and the temperature adjusting element is disposed along an outer circumference of the first part.

20. The scoop of claim 18, further comprising:
a handle,
wherein the power supply line is disposed to pass through an inside of the handle, and is connected to the temperature adjusting element without being exposed to outside of the handle.
